(19) United States
(12) Patent Application Publication
(10) Pub. No.: US 2004/0133720 A1
(43) Pub. Date: Jul. 8, 2004

(54) Embeddable single board computer

(76) Inventor: Steven Slupsky, Edmonton (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/707,391

(22) Filed: Dec. 10, 2003

Related U.S. Application Data
(60) Provisional application No. 60/319,828, filed on Dec. 31, 2002.

(51) Int. Cl. G06F 13/00

(52) U.S. Cl. 710/100

(57) ABSTRACT

An embeddable single board computer includes a microprocessor, memory and a PCI interface all operatively connected on a DIMM standard form factor.

### CROSS REFERENCE TO RELATED APPLICATIONS

This application claims the priority benefit of U.S. Provisional Patent Application No. 60/319,828 filed on Dec. 31, 2002, the contents of which are incorporated herein by reference.

### BACKGROUND OF INVENTION

This invention relates to embeddable single board computers.

Embedded computer systems are those without the conventional front-end or user interface of desktop or personal computers. Embedded computers are integrated into their environment such that a user may be unaware that a computer is providing functionality to the apparatus or system which includes the embedded computer.

The central processing unit (CPU) of a microcomputer typically consist of many circuit boards plugged into a backplane. A backplane operates much like an electrical junction box, and, more particularly, is an electronic circuit board containing circuitry and sockets into which additional electronic devices on other circuit boards or cards can be plugged. A backplane typically operates only as an intermediary board to provide pathways between the various ports, and the backplane is typically itself placed in data communication, via another plug, slot or socket on the backplane with another electronic circuit board, which in fact operates as the CPU for the device.

Embeddable single board computers (SBC) resulted from advances in integrated circuit technology which allowed functions which had previously occupied entire circuit boards to be crammed into single “large-scale integration ” or “LSI” logic chips. LSI chips for CPU, memory, storage and various ports or interfaces made it possible to implement complete microcomputer systems onto a single board without a backplane.

There are many well-known form factors in the case of embeddable SBC's such as Little Board™ (Ampro), ISA “slot boards”, PC/104 modules, CompactPCI, PC/104 Plus and EBX (Embedded Board, Expandable). The latter three added the well-known Peripheral Component Interconnect (PCI) bus standard to the SBC. However, these solutions suffer from the disadvantage of being very expensive because they are typically used in industrial niche applications.

There is a need in the art for a compact embeddable single board computer which is inexpensive and permits rapid and efficient application development.

### SUMMARY OF INVENTION

The present invention provides a single board computer implemented in a standard commercially available form factor-the Dual In-Line Memory Module (DIMM) form factor. In one aspect, the invention may comprise a single board computer wherein the board comprises a DIMM form factor, the computer comprising:

(a)a microprocessor;

(b)memory; and

(c)a PCI interface port;

wherein the memory and the PCI interface port are operatively connected to the microprocessor. In one embodiment, the PCI interface and microprocessor are integrated into a single chip. Alternatively, the microprocessor and the PCI interface may be physically separate chips.

PCI refers to Peripheral Component Interconnect. PCI is a standardized data transfer mechanism developed by a consortium of several companies and administered by a group known as the PCI Special Interest Group (PCI SIG) to ensure widespread compatibility between different peripheral devices, and avoid permutations of local bus architectures which varied, or which were peculiar to a specific processor bus. As it exists in 2003, the PCI standard calls for the ability to support up to 66 MHz operating speed. PCI specifications are well known in the art and may be obtained from PCI SIG. PCI Specifications such as the Conventional PCI Revision 2.2 Local Bus Specification, Dec. 18, 1998, which is hereby incorporated by reference, are described in detail and available from the PCI SIG.

By using PCI, a myriad of options are available to the embedded systems developer. The developer now may select from a range of high-volume PCI components conventionally used in desktop applications. This brings low-cost, high-performance, system-level solutions within reach of the embedded marketplace. Use of standard PCI technology enables a significant reduction in development effort. Using existing proven technology reduces time-to-market of both the hardware and software components.

In another aspect, the invention may comprise a computer network comprising a single board computer as described herein and including a network interface port and a workstation comprising a personal computer having a network interface port, wherein the personal computer is operatively connected to the single board computer by means of a local area network, wide area network or the Internet.

### BRIEF DESCRIPTION OF DRAWINGS

FIG. 1A is a schematic representation of the front side of one embodiment of an embeddable single board computer (SBC). FIG. 1B shows the reverse side of the SBC.

FIG. 2 is a schematic representation of a passive backplane for use in developing applications for a SBC of the present invention.

FIG. 3 is a schematic representation of the PCI interface architecture.

FIG. 4 is a schematic representation of a microprocessor with an integrated PCI bridge.

FIG. 5 is a schematic representation of a SBC serving as a web server.

FIG. 6 is a schematic representation of a SBC serving as a web server over a wired or wireless intranet or Internet connection.

### DETAILED DESCRIPTION

An exemplary implementation of the present invention combines a superset of the 32-bit, 33 MHz desktop PCI standard with a dual in-line memory module (DIMM) form factor. This form factor uses a high-volume, commercially available 168 pin DIMM interconnect component as specified by JEDEC Solid State Technology Association. Though the 168 pin standard dictates the overall width (across board-keyway), there are several acceptable overall heights. As well, DIMM form factors which employ more or less pins are also utilized, such as the SODIMM 144 pin form factors typically used for laptop computer memory modules. The term “DIMM” is intended to encompass any such form factor recognized by JEDEC, without regard to its size or number of pins. The use of a high-volume interconnect reduces system cost considerably, as can be seen when a comparison is done between the desktop market and other PCI technologies.

The acceptable sizes defined by the DIMM standard may improve reliability by reducing the mass of the circuit card considerably. Reliability is enhanced further by the presence of card locks at both ends of the DIMM connector. Easily manufactured and inexpensive braces also may be added to the middle of the circuit cards for additional support.

The following description of a single preferred embodiment is not intended to be limiting of the invention as claimed herein.

### System Architecture

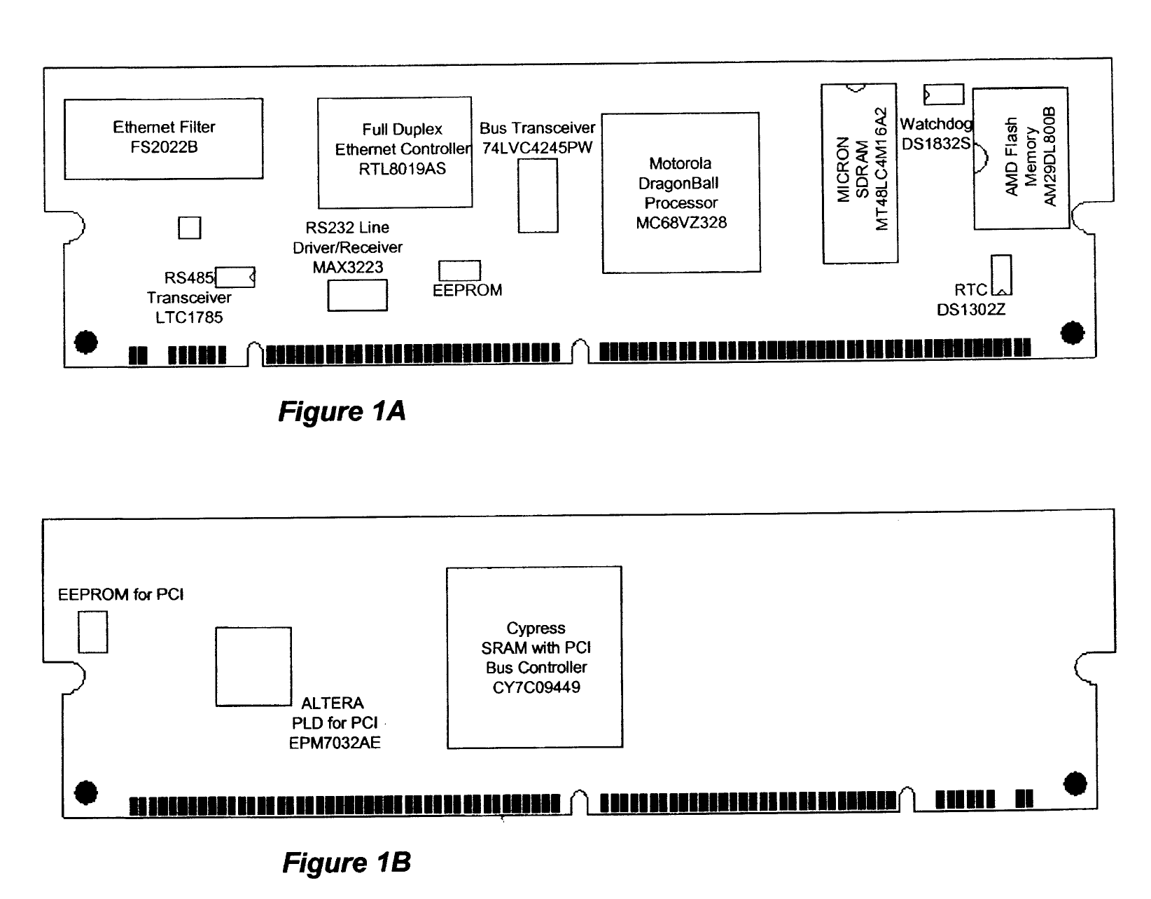

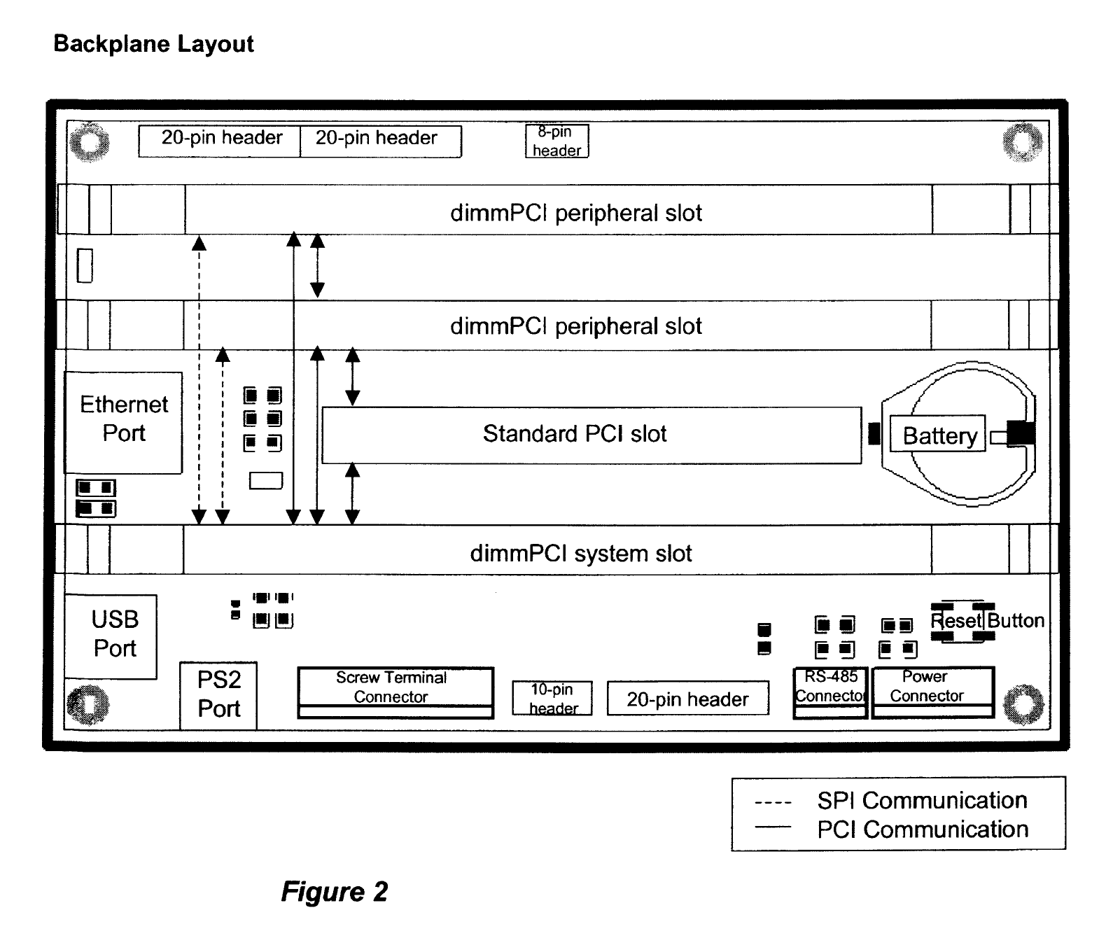

The hardware implementation of the present invention may address the needs of the embedded marketplace by focusing on scalability, physical size, flexibility, development costs and product cost. FIG. 1 schematically illustrates one embodiment of the invention as a single board computer (10), which may be referred to herein as the SBC module. FIG. 2 illustrates a passive developers' backplane (100) and the SBC module (10). The developers' backplane is intended to be used by other embedded system developers for quick application development. The backplane may include a standard desktop PCI slot to facilitate software development earlier in the cycle using standard PCI peripheral cards, as is shown in FIG. 2.

The architecture of a single board computer (10) of the present invention comprises four main functional regions: an Ethernet controller, a PCI interface, a microprocessor and system memory. Therefore, in one embodiment shown in FIG. 1, the SBC (10) comprises a microprocessor (12), memory (14), an Ethernet network interface (16), a PCI interface (18) and both RS 232 (20) and RS 485 (22) serial communication ports. In an alternate embodiment, the PCI interface and microprocessor may be integrated into a single chip.

The microprocessor may comprise any known computational engine contained on a single chip, or combination of chips. Preferably, the microprocessor comprises a 32-bit embedded processor. The microprocessor may comprise well known x86 chips or non-x86 chips such as IBM PowerPC™ or Motorola Dragonball™ chips. In a preferred embodiment, the microprocessor (12) comprises a Motorola Dragonball™ VZ microcontroller and the MC68VZ328 in particular. This microprocessor is preferred because it is based on a 68 K core and runs at higher speeds and lower power than many other components. The VZ328 is used in many popular PDAs on the market and has many features integrated into the device including:

FLX68000 CPU

chip-select logic and 8-16-bit bus interface

clock generation module (CGM) and power control

interrupt controller

76 GPIO lines grouped into ten ports

two pulse-width modulators (PWM 1 and PWM 2)

two general-purpose timers

two serial peripheral interfaces (SPI 1 and SPI 2)

two UARTs (UART 1 and UART 2) and infrared communication support

LCD controller

real-time clock

DRAM controller that supports EDO RAM, Fast Page Mode and SDRAM

in-circuit emulation module

bootstrap mode

### Operating System

The choice of an operating system may be made to be compatible with the microprocessor chosen and to preferably meet the following requirements: widely used, easily supported, ease of development, low-development costs, low per-unit licensing fees, support for wide range of hardware platforms and devices, code maintenance, qualified developers and maximized exploitation of the technology platform. In a preferred embodiment, the operating system comprises a Linux system and more preferably comprises a μClinux system. Of course, widely used and well-known operating systems from Microsoft Corporation may also be implemented by those skilled in the art.

Linux has existed in the desktop domain for a considerable length of time, and thus it has accumulated a significant knowledge base related to PCI development.

It is known in the art that the use of closed-source operating systems for embedded projects has created problems with code debug and trace during development. Another important consideration is off-the-shelf support for different filesystems, network stacks and peripheral devices. Finally, support for a wide range of hardware platforms is important for future development projects that require application migration to higher levels of performance.

The hardware platform of one embodiment includes the Motorola Dragonball™ VZ microcontroller. The Motorola Dragonball™ family devices use a large-endian memory format and alignment that is different from x86-based devices. The Dragonball™ also lacks a memory management unit (MMU) unlike microprocessors typically used in desktop computers. Typically, lower-cost processors lack an MMU, and many embedded applications are driven by cost. The software for these embedded applications does not require the benefits that an MMU would provide.

It is known that a full Linux kernel requires the presence of an MMU in the hardware system. Due to the absence of the MMU in the Dragonball™ processor, a process of porting a Linux kernel to this microprocessor architecture is required. μClinux is a Linux 2.0 (μClinux 2.4 also exists) kernel that has been ported to a Motorola 68 k family device that does not have an MMU. Some kernel services need to be adapted to work in an environment without an MMU. For example, services normally provided by the function forko may be accomplished with vfork(), given that care is used. Note that μClinux originally was ported to the Dragonball™ EZ processor. Implementation of one embodiment uses the Dragonball™ VZ and so requires some additional kernel modifications.

A major factor to consider for selection of an OS is a wide range of support for hardware platforms and peripheral components. It is preferred to have full software support for as many devices as possible. Thus, migrating an application to the architecture of the present invention mainly would involve a hardware form-factor change, with only minimal changes to the hardware design and application software. Device-driver design is one of the most substantial costs during software development. A large support base for peripheral devices and components, such as network interfaces, RAM, ROM, serial communications and displays, is essential for cost savings during the development phase. Linux is a preferred choice since the supported knowledge base includes source code, which facilitates the development of new devices by providing many examples and potential starting points for development. Linux also has a wide breadth of drivers available.

Performance is also a significant consideration. Linux is a multitasking operating system and provides a rich application development environment. Many practical embedded applications can be developed within this operating system environment. We have found that with properly written drivers, one can respond to hard real-time interrupts without having to preempt the kernel. For most applications, this is sufficient—especially given that the gcc tools compile C code into efficient code, and embedded assembly code can be written if response times are critical.

Certain applications may require a more deterministic response. Real-time extensions for Linux are known to those skilled in the art. Projects such as RTLinux and RTAI provide the necessary framework for providing real-time response within Linux. They operate on the principle that an RT kernel runs at the core with the Linux kernel scheduled as a low-priority task.

Filesystems for embedded applications require a level of robustness that exceeds that of normal desktop systems. In addition, they must support diskless storage and embedded devices. Achieving these requirements generally involves a sacrifice in efficiency and performance.

In one preferred embodiment, the filesystem comprises the Journaling Flash Filesystem (JOFFS). JFFS is specifically designed to minimize the risk of data loss from a system crash or uncontrolled shutdown for industry-standard Flash memories. It is included in the standard Linux 2.4 kernel and is available as an open-source patch for the Linux 2.0 kernel. JFFS is a log-structured list of nodes on the Flash media. Each node contains information about the associated file and possible file data. If data is present, the node will contain a field that indicates the location in the file where data should appear. This allows newer data to overwrite older data. The node also contains information about the amount and location of data to delete from the file. This information is used for truncating files or overwriting selected data within a file. In addition, each node contains information that is used to indicate the relative age of the node. In order to recreate a file, the entire media must be scanned, the individual nodes must be sorted in order of increasing version number and the data must be processed according to the instructions in each node. This is required only once when the filesystem is mounted.

JFFS writes to the Flash media in a cyclic manner. New nodes simply are appended until the end of the media is reached. Before reaching the end of the media, the first block of media must be freed for use. This is accomplished by copying all valid nodes (nodes that have not been made obsolete by later nodes) and then erasing the block. This inherent cyclic nature ensures wear-leveling of the Flash media.

As evident, JFFS is not an efficient means of storing and retrieving data. The number of bytes required to store a file can be more significant than the actual file size. However, this lack of efficiency is compensated for in terms of robustness and crash recovery, where JFFS rates highly. If the system crashes or experiences an unexpected loss of power, only the last node written might be affected. Thus, the file still can be recreated excluding the changes described by the last corrupted node.

### Memory

In one embodiment, the total memory capacity of the SBC-CPU may be 40 MB which may comprise both volatile and nonvolatile parts. The volatile memory capacity is 32 MB Synchronous Dynamic RAM (SDRAM). The amount or type of memory is not intended to be limiting of the claimed invention. When Linux was considered in the design process, one of the requirements that contributed to an early design iteration was the memory footprint. This requirement influenced the microprocessor selection because of the need for an integrated SDRAM controller. The SDRAM is preferably a MT48LC4M16A2 or compatible 3.0V SDRAM.

In one embodiment, the nonvolatile memory storage comprises 8 MB of Flash-based memory which is preferably AMD29DL800B or compatible 3.0V Flash ROM. Flash ROM is located at 0x100000000 in memory. The operating system kernel is located at the beginning of flash, the readonly root file system is located immediately after the kernel and the JFFS starts on the first sector boundary after the root file system. Total kernel requirements are 450 KB, and the root file system and JFFS requirement is 150-400 KB, depending on which standard Linux components are required for the application. This leaves approximately 7 MB of RAM free for user application and data.

A Dragonball™ VZ has four pairs of chip selects which are configurable as pairs: CSA0 and CSA1, CSB0 and CSB1, CSC0 and CSC1, and CSD0 and CSD1. Chip select pairs share a base address, the size of the addressable area, the number of wait states, and whether it is an 8-bit or a 16-bit chip select. When SDRAM is enabled, the Dragonball™ VZ consumes five of the chip selects. The 16-bit flash is assigned to CSA0 because that is the only chip select active after reset. The wait states are set for internal timing.

The 16-bit PCI interface is preferably a synchronous interface and must be attached to CSB0, which is configured for external timing.

The Ethernet chip supports either 8 or 16 bit interface, however, because most NE2000 compatible drivers have been written for an 8-bit interface, the device has been interfaced as an 8 bit device attached to CSA1. Because the chip select pair must be configured as 16-bit to support the 16-bit flash, the registers of the eEthernet chip will appear at every other byte address rather than a block of contiguous bytes.

The mapping of I/O memory intro the CPU's main memory takes place at two different locations. At 0xFFFFF000, the microprocessor registers and boot microcode fill the available memory to the end of the CPU memory. The ethernet controller is mapped off the microprocessor's CSA1 chip select and is located at 0x10400000. The following table provides memory map information:

TABLE 1

| | | Chip |
|---|---|---|
| Address Range | Function | Select |
| 0x00000000 to 0x000003FF | interrupt vector table | |
| 0x00000400 to 0x01FFFFFF | SDRAM | CSD0 |
| 0x01FFFFFF to 0x0FFFFFFF | unimplemented space | |
| 0x10000000 to 0x103FFFFF | FLASH ROM | CSA0 |
| 0x10400000 to 0x107FFFFF | Realtek Ethernet Controller | CSA1 |
| 0x10800000 to 0x1FFFFFFF | unimplemented space | |
| 0x20000000 to 0x2001FFFF | PCI | CSB0 |
| 0x20020000 to 0xFFFFEFFF | unimplemented space | |
| 0xFFFFF000 to 0xFFFFFDFF | DragonBall VZ Registers | |
| 0xFFFFFE00 to 0xFFFFFFFF | DragonBall VZ Boot Microcode | |

The kernel is stored using the ROM filesystem and is set to execute in place. If necessary or desired, nonvolatile memory requirements can be reduced in part by using CRAMFS. CRAMFS is a special type of filesystem that uses compression to store information. The executables are decompressed to RAM for execution.

### Networking and Serial Communication

In one embodiment, a network interface comprises a 10 Mbps 10Base-T interface (Ethernet). The Ethernet controller can be a RealTek RTL8019AS Ethernet controller and all the supporting circuitry to implement a 10BaseT ethernet port with no external components. In addition to Ethernet, a serial RS-232 port and a serial RS-485 port have been included. The SBC-CPU may include an industry-standard, serial peripheral interface (SPI) physical layer bus. This bus can be used for communicating with low-bandwidth peripherals.

### PCI Architecture

In a preferred embodiment, the PCI interface is constructed around a controller which is an integrated PCI bridge, master/slave direct memory access controller, message transport unit and memory. The Cypress CY7C09449PC-AC bus controller is a suitable example. Alternatively, the PCI interface can be integrated with the processor in a single chip, as is shown in FIG. 4. IBM PowerPC□ microprocessors are known to have integrated PCI interfaces.

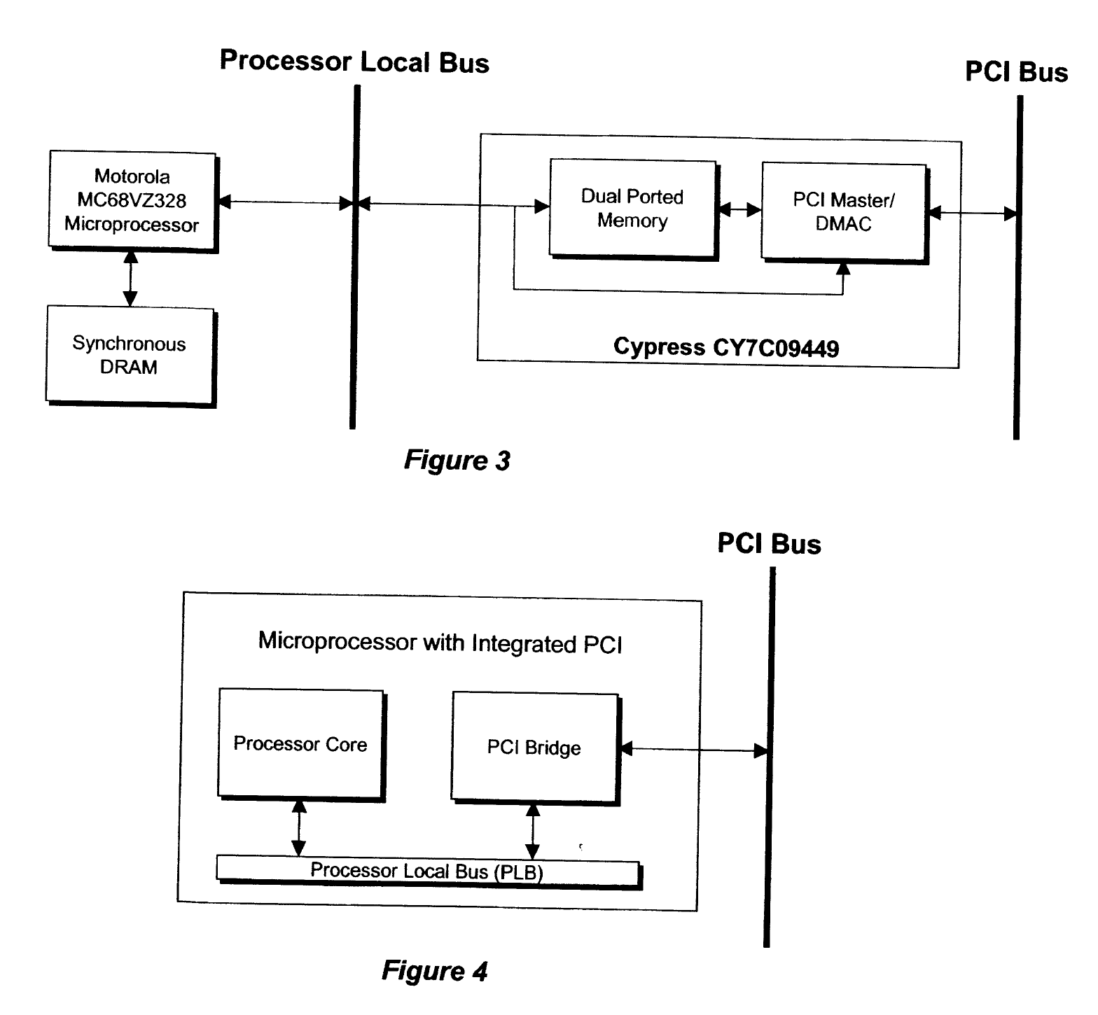

The PCI architecture used in the embodiment described herein and shown in FIG. 3 is dictated principally by the Motorola Dragonball™'s (VZ328) inability to support multiple masters on the address and control buses. It is possible to insert buffers to isolate the VZ328 address and control signals. Such an implementation would suffer however, because another external device that gains control of the bus would not have access to the peripherals internal to the VZ328. These include functions such as chip-select logic and, most importantly, the SDRAM memory interface. Therefore, little is to be gained by adding the external buffer logic.

A solution exists where a dual-ported memory is used to interface the PCI bus with the Dragonball™ microprocessor, as shown schematically in FIG. 3. Cypress Semiconductor offers a component with a dual-ported memory and PCI Master/Target interface combined into one integrated circuit. The Cypress Cy7C09449 acts as a bridge in this implementation. This results in two distinct address spaces: one for the VZ328 and one for the PCI. A PCI arbitrator may be provided to govern traffic to and from the PCI bus.

The preferred embodiment implements a modified version of the PCI Specification 2.1 for embedded applications.

### Linux Support for PCI

In the Linux kernel (2.0.38) used as a starting point, support for PCI peripherals is extensive but is completely dependent on BIOS calls for PCI configuration. This works well for PCs but is not so well suited for implementing PCI for an embedded system. We believe that all Linux implementations of PCI use the BIOS. Therefore, in one embodiment, the starting point was to give the PCI BIOS functionality in order to make use of the base Linux PCI driver.

Most developers are familiar with PCI in the Intel x86 environment. It is important to note that such an implementation is a special case. In the special case, the PCI memory address space and the host processor (386, 486, Pentium, Athlon), physical address space are one and the same. The bridge arrangement required by the VZ328 architecture described above is the more general case.

There are other significant development issues as well. These stem from the reality that most PCI development is for products intended for the desktop. In addition to the above problem, other problems involved in porting PC drivers to our embedded platform include: 1) byte order is generally ignored as x86s and PCI are the same; 2) word alignment is generally poor on x86s as these processors automatically generate multiple bus cycles; 3) new hardware still reflects ISAs (industry-standard architectures, i.e., AT) by using the same I/O register maps, rather than introducing improved memory space register maps; and 4) drivers, especially video drivers, sometimes rely on expansion ROMs that contain x86 binary code, which assumes the existence of PC peripheral devices and specific x86 PC BIOS software interrupt vectors.

One consequence of using the Motorola VZ328 microprocessor is that placing the memory onto the PCI bus would transform the architecture into the special case of the PC, at increased cost and complexity.

PCI BIOS Development

The PCI BIOS must do two things. It must allocate memory space, I/O space and interrupts. It also must allow a device driver access to PCI configuration cycles that allow the device driver to find the card, read the card resources and be able to configure the card as necessary.

The PCI BIOS calls have been extended to provide a hardware abstraction layer to compensate for having a split memory address space. These functions are summarized as follows:

pcibios_read_memory_byte()

pcibios_write_memory_byte()

pcibios_read_memory_word()

pcibios_write_memory_word()

pcibios_read_memory_dword()

pcibios_write_memory_dword()

The VZ328, unlike x86 processors, does not have both a memory address space and an I/O address space. The VZ328 itself cannot generate an I/O cycle, nor does it need to. The VZ328 must communicate the PCI I/O address to the bridge, as required for PCI memory addresses, and must communicate a request to the bridge for a PCI I/O cycle. The PCI BIOS calls have been extended with the addition of the following functions to support I/O cycles:

pcibios_read_io_byte()

pcibios_write_io_byte()

pcibios_read_io_word()

pcibios_write_io_word()

pcibios_read_io_dword()

pcibios_write_io_dword()

The VZ328, unlike x86 processors, is a large-endian device. PCI has been defined to work well with x86 devices, which are small-endian. Since most PCI data transfers are word or dword (i.e., few byte transfers), it is advantageous to avoid byte swapping on every word or dword access, so the data bus between the bridge and the VZ328 has been swapped in hardware. A side-effect result is that byte accesses now must be corrected by inverting the least significant address bit (A0). Fortunately, this is handled in the supplied PCI BIOS calls (and in the above extensions), so the details largely are hidden by the PCI BIOS:

pcibios_read_config_byte()

pcibios_write_config_byte()

pcibios_read_config_word()

pcibios_write_config_word()

pcibios_read_config_dword()

pcibios_write_config_dword()

Most transfers on the PCI bus are accomplished using direct memory access (DMA) bus cycles. These transfers can be initiated by any PCI device to any memory address reachable on the PCI bus. Since the VZ328 address space is separate from the PCI address space, PCI DMA transfers cannot specify a source or destination that is within the VZ328 memory space.

The Cypress™ Cy7C09449 contains a 32 KB dual-ported memory that is used to bridge the VZ328 memory space to PCI memory space. Since there may be more than one PCI device in a system, there can be more than one PCI device driver installed at any given time. This condition compels us to treat the dual-ported memory as a shared resource and to balance efficiency with performance.

The kernel function kmalloco, which calls get_free_pages(), was designed to allocate such special memory using GFP_flags. GFP_DMA is defined for PC implementations and denotes a page that is bounded by a 16 M memory limit and does not cross a 64 K boundary (this was due to the limitations of the 8237 DMA controller at the time).

Since PCs share processor and PCI memory address spaces, there is no special flag defined to select memory for use with DMA and PCI. It appears that the PC standard here is designed around the special case. To compound the problem, there is no central resource to initiate a DMA transfer, as device drivers initiate transfers by writing to nonstandard registers on the device hardware. Generally speaking, this code needs to be altered to become bridge-aware. Therefore, to facilitate sharing the dualported RAM on the bridge, the PCI BIOS has been extended to include kmalloc memory tables and a GFP_PCI flag. A device driver may allocate and deallocate DPram on a transfer-by-transfer basis or request a block of memory that it will own permanently, until the device driver is closed.

Finally, interrupts are handled using the register_interrupt( ) system call. PCI specifies an 8-bit field for interrupt number, so the VZ328 PCI BIOS can assign a mach interrupt number that can be handled by a device driver using the register_interrupto system call.

### Signal Descriptions

The complete listing of signal descriptions of the preferred embodiment described herein is shown below in Table 2:

TABLE 2

| Pin # | SideA | SideB |
|---|---|---|
| 1 | ETHRX− | ETHTX− |
| 2 | ETHRX+ | ETHTX+ |
| 3 | | |
| 4 | | |
| 5 | ETHLNKLED | ETHACTLE |
| 6 | VBAT | EGND |
| 7 | P/D | EMUIRQ |
| 8 | EMUBRK | EMUCS |
| 9 | Ground | Ground |
| 10 | SCIB+ | SCIB− |
| 11 | SCIARTS | SCIACTS |
| 12 | SCIARXD | SCIATXD |
| 13 | Reserved | Reserved |
| 14 | LCONTRAST | Reserved |
| 15 | LFRM | LLP |
| 16 | LCLK | LACD |
| 17 | LCD1 | LCD0 |
| 18 | LCD3 | LCD2 |
| 19 | Ground | Ground |
| 20 | USER | USER |
| 21 | +5 V | D− |
| 22 | D+ | Ground |
| 23 | +5 V | SPIINT1 |
| 24 | SPIINT0 | CS0 |
| 25 | CS1 | CS2 |
| 26 | CS3 | SS |
| 27 | MISO | +5 V |
| 28 | Ground | MOSI |
| 29 | SCLK | Ground |
| 30 | +3.3 V (I/O) | +3.3 V (I/O) |
| 31 | AD[01] | AD[00] |
| 32 | Ground | AD[02] |
| 33 | AD[03] | Ground |
| 34 | AD[05] | AD[04] |
| 35 | +3.3 V | AD[06] |
| 36 | AD[07] | +3.3 V |
| 37 | AD[08] | C/BE[0]# |
| 38 | M66EN | AD[09] |
| 39 | AD[10] | Ground |
| 40 | AD[12] | AD[11] |
| 41 | Ground | AD[13] |
| 42 | AD[14] | +3.3 V |
| 43 | C/BE[1]# | AD[15] |
| 44 | +3.3 V | PAR |
| 45 | SERR# | Ground |
| 46 | +3.3 V | SBO# |
| 47 | PERR# | SDONE |
| 48 | LOCK# | +3.3 V |
| 49 | Ground | STOP# |
| 50 | DEVSEL# | Ground |
| 51 | +3.3 V | TRDY# |
| 52 | IRDY# | Ground |
| 53 | Ground | FRAME# |
| 54 | C/BE[2]# | +3.3 V |
| 55 | AD[17] | AD[16] |
| 56 | +3.3 V | AD[18] |
| 57 | AD[19] | Ground |
| 58 | AD[21] | AD[20] |
| 59 | Ground | AD[22] |
| 60 | AD[23] | +3.3 V |
| 61 | C/BE[3]# | IDSEL |
| 62 | +3.3 V | AD[24] |
| 63 | AD[25] | Ground |
| 64 | AD[27] | AD[26] |
| 65 | Ground | AD[28] |
| 66 | AD[29] | +3.3 V |
| 67 | AD[31] | AD[30] |
| 68 | +3.3 V(I/O) | Reserved |
| 69 | REQ# | Ground |
| 70 | Ground | GNT# |
| 71 | CLK | +3.3 V(I/O) |
| 72 | Ground | CLK1 |
| 73 | CLK2 | Ground |
| 74 | SYSEN# | CLK3 |
| 75 | RST# | PRST# |
| 76 | +5 V | +3.3 V(I/O) |
| 77 | INTD# | +5 V |
| 78 | INTB# | INTC# |
| 79 | +5 V | INTA# |
| 80 | REQ3# | +5 V |
| 81 | REQ2# | GNT3# |
| 82 | Ground | GNT2# |
| 83 | REQ1# | +12 V |
| 84 | −12 V | GNT1# |

### Potential Applications

The present invention has been developed with several applications in mind, including asset management, remote-access data acquisition and instrumentation, industrial networking and control, security and power management. Using well-known Internet technologies, an SBC (10) of the present invention may be employed in a wide variety of internet appliances that brings the graphical environment of a web browser to small embedded devices. As well, the SBC may be employed in a wide variety of industrial control applications. The internet appliances and industrial control applications may include, without limitation, industrial monitoring and control, industrial networking, asset management, security applications. The platform of the present invention differs significantly from other embedded implementations, most notably in its ability to act as a web server directly bypassing the need to have a data server.

The function or application of the SBC is limited only by the applications which can be prepared by those skilled in the art.

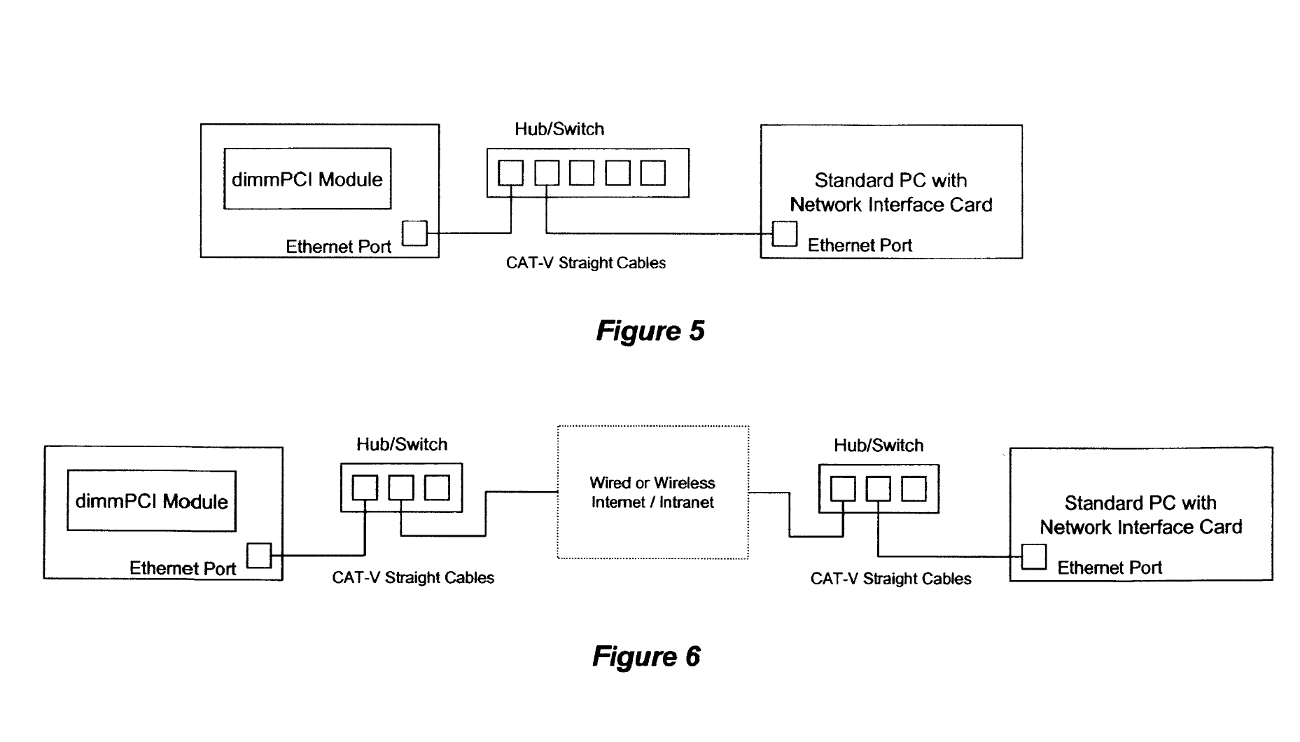

In one example, as shown in FIG. 5, an SBC may connect to a PC workstation via its Ethernet port, through a standard hub or switch. Alternatively, as shown in FIG. 6, an SBC may connect via its Ethernet port to an intranet or the Internet, either on a wired or wireless network. The SBC may then communicate with any standard PC workstation that is also connected to the network. Using such a configuration, the SBC may be employed in a remote location to gather, store, analyze, reconfigure and transmit data or data reports, for example.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

1. A single board computer wherein the board comprises
a DIMM form factor, the computer comprising:
(a)a microprocessor;
(b)memory; and
(c)a PCI interface port;
wherein the memory and the PCI interface port are operatively connected to the microprocessor.

2. The single board computer of claim 1 wherein the microprocessor and PCI interface port are integrated into a single chip.

3. The single board computer of claim 1 further comprising a network interface port.

4. The single board computer of claim 23 wherein the network interface port comprises, either singly or in combination, an Ethernet interface port, an RS232 interface port, or an RS 485 interface port.

5. The single board board computer of claim 1 further comprising an embedded operating system.

6. The single board computer of claim 45 wherein the operating system comprises a Linux system.

7. The single board computer of claim 1 wherein the memory comprises both volatile and non-volatile memory.

8. A web-server comprising:
(a)a single board computer as claimed in claim 3; and
(b)a workstation comprising a personal computer having a network interface port, operatively connected to the single board computer by means of a local area network, wide area network or the Internet.
